(19) United States
(12) Patent Application Publication
(10) Pub. No.: US 2007/0133447 A1
(43) Pub. Date: Jun. 14, 2007

(54) Dual CTS protection systems and methods

(75) Inventor: Menzo Wentink, Utrecht (NL)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Conexant Systems, Inc.

(21) Appl. No.: 11/638,157

(22) Filed: Dec. 13, 2006

Related U.S. Application Data
(60) Provisional application No. 60/750,114, filed on Dec. 13, 2005.

(51) Int. Cl. H04B 7/00

(52) U.S. Cl. 370/310; 370/346

(57) ABSTRACT

Various embodiments of the present disclosure provide dual CTS protection (DCTS) systems and methods. One method embodiment, among others, comprises receiving a first frame of a transmit opportunity (TXOP), and sending a short frame with a modulation that depends on whether the first frame is an extended range or normal range frame.

### CROSS-REFERENCE TO RELATED APPLICATION

This application claims priority to co-pending U.S. provisional application entitled, “Dual CTS Protection,” having Ser. No. 60/750,114, filed Dec. 13, 2005, which is entirely incorporated herein by reference.

### BACKGROUND

1. Field of the Invention

The present disclosure is generally related to communication systems and methods and, more particularly, is related to collision avoidance systems and methods in wireless networks.

2. Related Art

Communication networks come in a variety of forms. Notable networks include wireline and wireless. Wireline networks include local area networks (LANs), DSL networks, and cable networks, among others. Wireless networks include cellular telephone networks, classic land mobile radio networks and satellite transmission networks, among others. These wireless networks are typically characterized as wide area networks. More recently, wireless local area networks and wireless home networks have been proposed, and standards, such as Bluetooth and IEEE 802.11, have been introduced to govern the development of wireless equipment for such localized networks.

A wireless local area network (LAN) typically uses infrared (IR) or radio frequency (RF) communication channels to communicate between portable or mobile computer terminals and access points (APs) or base stations. These APs are, in turn, connected by a wired or wireless communications channel to a network infrastructure which connects groups of access points together to form the LAN, including, optionally, one or more host computer systems.

Wireless protocols such as Bluetooth and IEEE 802.11 support the logical interconnections of such portable roaming terminals having a variety of types of communication capabilities to host computers. The logical interconnections are based upon an infrastructure in which at least some of the terminals are capable of communicating with at least two of the APs when located within a predetermined range, each terminal being normally associated, and in communication, with a single one of the access points. Based on the overall spatial layout, response time, and loading requirements of the network, different networking schemes and communication protocols have been designed so as to most efficiently regulate the communications.

IEEE Standard 802.11 (“802.11 ”) is set out in “Wireless LAN Medium Access Control (MAC) and Physical Layer (PHY) Specifications” and is available from the IEEE Standards Department, Piscataway, N.J. The IEEE 802.11 standard permits either IR or RF communications at 1 Mbps, 2 Mbps and higher data rates, a medium access technique similar to carrier sense multiple access/collision avoidance (CSMA/CA), a power-save mode for battery-operated mobile stations, seamless roaming in a full cellular network, high throughput operation, diverse antenna systems designed to eliminate “dead spots,” and an easy interface to existing network infrastructures. The IEEE Standard 802.1 lb extension supports data rates up to 11 Mbps.

In wireless LANs, a protocol referred to popularly as carrier sense multiple access/collision avoidance (CSMA/CA) is implemented to allow sharing of a wireless medium between devices. The 802.11 standard provides for virtual carrier sensing, which is based on a network allocation vector (NAV) indicated as a duration found in a media access control (MAC) header of a given frame. During an access interval of this specified NAV duration, the medium is reserved by the device that set the NAV (and recipient devices that detected the NAV) to avoid collisions of frames. For instance, a common way to provide NAV protection prior to a data frame exchange is by using a request to send / clear to send (RTS/CTS) exchange, where the RTS and the CTS are transmitted at a basic rate that enables all nodes in a network to receive the frames. Each frame (RTS/CTS) sets a NAV locally at and around the respective transmitter.

One problem today is that technological advances may alter some of the protection previously afforded by conventional carrier sense mechanisms. For instance, networks may comprise a mix of extended range (ER) capable stations (e.g., space-time block code modulations, among others), non-ER capable stations (also referred to as normal range or NR stations), and legacy stations, which are also considered NR stations (e.g., orthogonal frequency division multiplexing (OFDM), among others). STBC modulations provide an illustration of ER modulations because STBC increases not only the range for unicast (i.e. directed) transmissions, but also for broadcast or multicast transmissions. In the 5 giga-Hertz (GHz) band, for instance, the same effect can be achieved by using the 1 mega-bits per second (Mbps) direct sequence spread spectrum (DSSS) modulation (the use of 1 Mbps DSSS is currently not allowed in the 5 GHz band). The support for STBC is optional in various 802.11 specifications, resulting in a network that contains a mix of stations that do and do not support STBC. With extended ranges, further distances for communication are enabled, but at the potential expense of rendering conventional NAV protections ineffective or at least less than optimal.

### SUMMARY

Embodiments of the present disclosure provide dual CTS protection (DCTS) systems and methods. One method embodiment, among others, comprises receiving a first frame of a transmit opportunity (TXOP), and sending a short frame with a modulation that depends on whether the first frame is an extended range or normal range frame.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of an exemplary environment in which various embodiments of dual CTS protection (DCTS) systems and methods may be implemented.

FIGS. 2 is a block diagram that illustrates a mechanism employed by the DCTS system shown in FIG. 1 for providing NAV protection for an RTS sent by a station using extended range (ER) modulation.

FIG. 3 is a block diagram that illustrates a mechanism employed by the DCTS system shown in FIG. 1 for providing NAV protection for an RTS sent by a station using normal range (NR) modulation.

FIG. 4 is a block diagram that illustrates a mechanism where the DCTS system shown in FIG. 1 refrains from sending a second CTS.

FIGS. 5-8 illustrate various mechanisms by which the DCTS system shown in FIG. 1 provides NAV protection by beginning NR transmit opportunities (TXOPs) with an extended range short frame and beginning ER TXOPs with an NR short frame.

FIGS. 9-10 are a flow diagrams that illustrate method embodiments corresponding to the mechanisms shown in FIGS. 2-4.

FIGS. 11-13 are flow diagram that illustrates method embodiments corresponding to the mechanisms shown in FIGS. 5-8.

### DETAILED DESCRIPTION

Disclosed herein are various embodiments of dual CTS protection systems and methods in a wireless network (herein, simply DCTS systems). The DCTS systems described herein comprise functionality to provide network allocation vector (NAV) protection for networks which contain a mix of extended range (ER) capable stations (also referred to as ER stations or the like, which use modulation schemes such as space-time block code (STBC), direct sequence spread spectrum (DSSS), complimentary code keying (CCK), among others), non-ER capable stations (also referred to as normal range or NR stations), and legacy stations, which also are considered to be NR stations and used herein interchangeably with NR stations (e.g., which use modulation schemes such as orthogonal frequency division multiplexing (OFDM), 802.1 In modulation code schemes, among others). Note that non-ER (NR) capable stations will also have a scope that herein encompasses 5 giga-Hertz (GHz) OFDM embodiments.

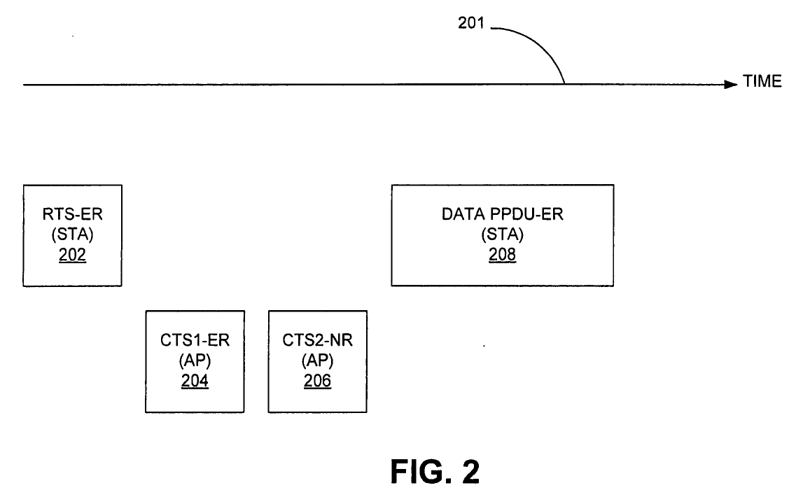

A proposal has been made for the upcoming 802.1 In standard to increase the effective communication range by using modulations (ER modulations) which have a longer range than existing modulations, and to transmit a second beacon using this ER modulation. The second beacon enables stations to receive the beacon and associate to the access point (AP) outside a legacy range (e.g., when authentication and (re)association frames are also transmitted using an ER modulation). However, transmissions from these remote stations (ER stations) can not be NAV protected using the regular (conventional) RTS/CTS mechanisms because the legacy basic rate (which is used to enable decoding of frames by all nodes in the network) is not sufficient to enable frames to reach the AP. FIGS. 2-13 illustrate various mechanisms employed by certain embodiments of the DCTS systems that provide for NAV protection under these and other wireless environments.

Although described in the context of a wireless local area network (WLAN) environment having a basic service set (BSS) configured in an infrastructure mode, the various embodiments of the DCTS systems described herein can similarly be applied to other communication system environments. Additionally, although IEEE 802.11 is prominently used herein as an example of a standard used in the exemplary wireless networks described herein, the systems and methods herein described may apply to virtually any wireless network known to one of ordinary skill in the art.

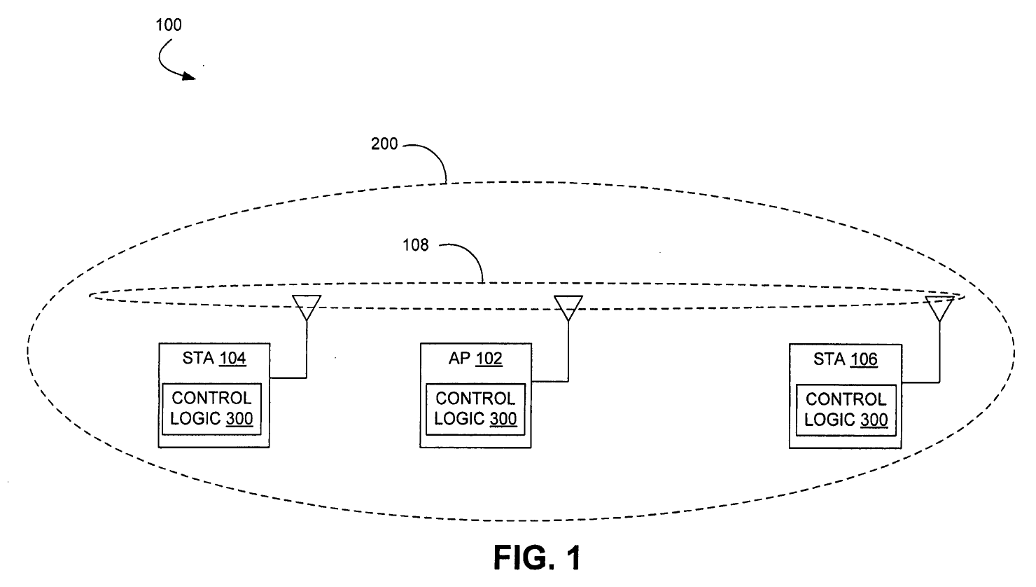

FIG. 1 show an exemplary WLAN environment 100 in which various embodiments of dual CTS protection (DCTS) systems 200 may be implemented. In general, the DCTS system 200 is configured as a basic service set (BSS), which comprises a plurality of stations or nodes (102, 104, and 106). As indicated above, the DCTS system 200 may comprise nodes with different capabilities. For instance, one or more of the stations 102, 104, and 106 may be configured to receive and transmit using an ER modulation (and hence referred to herein as ER-capable or the like), NR modulation (which includes legacy modulations), or with the ability to transmit or receive data frames using one or the other type of modulation within a single device. Note that frames or devices (e.g., stations) that have an ER or NR as a prefix or suffix (e.g., ER-CTS, CTS-ER, NR station, etc.) will herein be understood to refer to the associated modulation. Where ER or NR is used in isolation, it will herein be understood to refer to an ER modulation scheme and NR modulation scheme, respectively. Each of the stations 102, 104, and 106 may be embodied as one of many wireless communication devices, including computers (desktop, portable, laptop, etc.), consumer electronic devices (e.g., multi-media players), compatible telecommunication devices, personal digital assistants (PDAs), or any other type of network devices, such as printers, fax machines, scanners, hubs, switches, routers, set-top boxes, televisions with communication capability, etc.

The DCTS system 200 shown in FIG. 1 comprises, in one embodiment, an access point (AP) station 102 (herein, simply AP) and one or more client stations 104, 106 (herein, simply referred to individually or collectively as a station or stations). The DCTS system 200 is configured in what may be referred to as an infrastructure mode, whereby stations 104 and 106 communicate frames directly with the AP 102 and not with each other, though not limited to such configurations. The AP 102 is typically connected to a wired network (e.g., Ethernet), not shown. In general, the stations, such as station 104, connect to the AP 102 through a scanning process. The scanning process can either be performed passively by listening for a beacon transmitted by one or more APs 102, or actively by sending out probes to one or more APs 102 and choosing an AP that provides the best connection (e.g., in terms of signal strength and/or bit error ratio (BER)). In active scanning, as used in 802.11 systems for instance, stations select a given channel and send a broadcast probe request frame and wait for any probe responses to be received. An ER-capable station may send, in addition to a NR probe request, an ER probe request; the latter sent to find APs which support ER modulations yet are outside of the NR range. In some embodiments, an ER-capable AP which receives an ER probe request responds with an ER probe response to ensure that the probe response has sufficient range to reach the scanning station. In another embodiment, the AP uses a unicast range extending mechanism to increase the range of the probe response. An example of a unicast range extending mechanism is beamforming.

After an AP is chosen, such as AP 102, an authentication process occurs between the station 104 and the AP 102, and then association between the same may begin. Association involves the communication between the stations 104, 106 and the AP 102 via a shared wireless medium 108. When outside of normal range, the authentication and association procedures should be carried out using (unicast) extended range modulations.

Included within each of the AP 102 and stations 104, 106 is control logic 300. The control logic 300 implements MAC layer and PHY layer services. The MAC layer services provide the capability for the given AP 102 and stations 104, 106 to construct and exchange MAC frames. The MAC frames comprise management, control, or data frames exchanged between the AP 102 and stations 104, 106. After an AP 102 or station 104, 106 forms the applicable MAC frames, the frame bits are passed to the PHY layer for transmission.

The control logic 300 can be implemented in hardware, software, or a combination thereof. When implemented in whole or in part by software, control logic 300 is implemented in software stored in a memory and that is executed by a suitable instruction execution system. When implemented in whole or in part by hardware, the control logic 300 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In one embodiment, the control logic 300 may include a PHY layer processor, MAC layer processor, or a combination of both (in the same or separate units), including, but not limited to, a digital signal processor (DSP), a microprocessor (MCU), a general purpose processor, and an application specific integrated circuit (ASIC), among others. One skilled in the art would understand that the control logic 300 can be configured using a plurality of modules (e.g., hardware and/or software) with distinct functionality, or as a single module.

In the course of providing MAC layer services, the control logic 300 is configured to provide MAC protocol data units (PDUs), each of which comprise a fixed-length MAC header, a variable length payload, and a mechanism for error correction functionality. The control logic 300 is further configured with added fields to the well-known HT information element field (e.g., two 1-bit wide fields) of the MAC header. The added fields are referred to herein as dual CTS protection support, which indicates whether dual CTS protection is used, and dual beacon, which indicates whether a secondary ER beacon is present.

These added fields, among others, of the HT information element are further described with the assistance of Table 1 below:

TABLE 1

| | | |
|---|---|---|
| Dual CTS | 0 = regular use of | Dual CTS protection is |
| protection | RTS/CTS | used by the AP to set a |
| | | NAV at stations which do |
| | 1 = dual CTS protection | not support ER and at |
| | is used (1 bit) | stations which can |
| | | associate solely through |
| | | the secondary (ER) beacon |
| Dual beacon | 0 = no secondary beacon | Indicates whether the AP |
| | is transmitted by the AP | transmits a secondary |
| | | beacon. |
| | 1 = a secondary beacon | |
| | is transmitted by the AP | |
| | (1 bit) | |
| Basic ER MCS | Any rate from MCS set | Present in beacon/probe |
| | (6 bits) | response frames to indicate |
| | | what MCS shall be used |
| | | for ER control frames and |
| | | ER beacon. |

If the dual CTS protection bit is set (enabled), then the AP will attempt to respond with a dual CTS in response to a received RTS. One CTS will be transmitted using an NR modulation, and the other CTS will be transmitted using ER modulation, so that both groups of devices (ER and NR) will be protected against interfering with the pending TXOP.

In general, the AP 102 protects ER transmit opportunities (TXOPs) with a non-ER CTS and non-ER TXOPs with an ER CTS. Note that, in general, a TXOP initiated by the AP 102 may begins with an RTS or CTS and ends with the last frame sent or received by the AP. The AP 102 may continue PCF interframe space (PIFS) time after the CTS to allow for collision detection. The protection frames (RTS and/or CTS) set a NAV for the entire TXOP. In particular, if dual the CTS protection bit is set, stations 104, 106 may start a TXOP with an RTS directed at the AP 102. In one embodiment, the AP 102 responds with a dual CTS in the manner described in Table 2 below:

TABLE 2

| | non-ER RTS | ER RTS |
|---|---|---|
| First CTS (CTS1) | Same rate or MCS as the | Lowest basic ER MCS |
| | RTS (non-ER) | (ER) |
| Second CTS (CTS2) | Lowest basic ER MCS | Lowest basic rate (non- |
| | (ER) | ER) |

Note that the use of the terms “basic rate” and “non-basic rate” are understood herein in the context of 802.11 systems, wherein a basic rate refers to a rate that is to be supported by all stations in a BSS. Further, a non-basic rate may not be supported by all stations in a BSS, but is supported by the AP and the communicating station. In general, a suitable rate varies depending on the implementation. For instance, in some embodiments, the control logic 300 may include a proprietary (or otherwise) rate adaptation algorithm that determines an optimal rate for communicating with a particular destination. Further, to ensure that all ER capable stations support at least a single mean ER rate, the AP may define and distribute a basic modulation code scheme (MCS) or a basic ER MCS set. The use of such a set is similar to an NR basic MCS set in that it is used to determine the MCS for a control response frame.

With regard to ER RTS, SIFS time is used as the interval between the first CTS and the second CTS. Further, for ER RTS, the station sending the RTS resumes PIFS plus CTS2 plus short interframe space (SIFS) time after receiving CTS1, instead of after SIFS (i.e. when no dual CTS is used). The time it takes to transmit CTS2 is known in advance according to the above definitions.

With regard to non-ER RTS, PIFS time is used as the interval between the first CTS and the second CTS. If the medium becomes busy within a PIFS time following the first CTS (CTS1), then the second CTS (CTS2) is not transmitted as part of this frame exchange (i.e., CTS2 is transmitted if the medium is idle). Further, for non-ER RTS, the station sending the RTS resumes PIFS plus CTS2 plus short interframe space (SIFS) time after receiving CTS1, instead of after SIFS. The time it takes to transmit CTS2 is known in advance according to the above definitions. One skilled in the art would appreciate from the context of this disclosure that other variations are possible. For instance, for ER RTS in some embodiments, the AP sends the second CTS (CTS2) SIFS time after the first CTS (CTS1), and the station sending the RTS resumes SIFS plus CTS2 plus SIFS time after receiving CTS1, instead of after SIFS (i.e. when no dual CTS is used). In some embodiments, for ER RTS, the time between CTS1 and CTS2 may also be PIFS instead of SIFS, which simplifies the dual CTS rules. In some embodiments, the stations 104, 106 resume PIFS plus CTS2 plus SIFS time after receiving CTS1, for both STBC and non-STBC RTS. In some embodiments, the RTS is transmitted using a unicast range enhancement method such as beamforming, rather than an omnidirectional range enhancement method such as STBC. The first CTS in this case still uses an omnidirectional range enhancement method, such as STBC. In some embodiments, the order of the CTS responses is fixed independent of the modulation type of the RTS. More specifically, in this case the first CTS (CTS1) is transmitted using an NR modulation, followed by a PIFS interframe space, followed by the second CTS (CTS2), which is transmitted using an NR modulation. The station sending the RTS continues to transmit after a time equal to SIFS plus CTS1 plus PIFS plus CTS2 plus SIFS after sending the RTS, provided that it received at least one CTS during this time period. In other embodiments, the PIFS time is replaced with a SIFS time. In other embodiments, the SIFS time is replaced with a time which is even shorter than SIFS, such as the reduced interframe space (RIFS).

Although described above and below in the context of the AP 102 or station 104,106 sending or receiving various transmissions, it would be understood in the context of this disclosure that the effectuating of the various functionality of the DCTS system 200 is through the control logic 300 of each AP 102 or station (node) 104, 106. Further, the various interframe spaces described in 802.11 and understood by those having ordinary skill in the art are omitted from the various figures (and in some cases the corresponding description) except where helpful to the understanding of the various embodiments.

FIG. 2 is a block diagram that illustrates one mechanism employed by the DCTS system 200 for providing NAV protection. The labeled blocks (e.g., RTS-ER, CTS-ER, etc.) represent frames sent by a device identified in parenthesis (e.g., AP 102 or stations (STA) 104, 106) in each block. Further identifying the type of device is the location of the frame with respect to the relative vertical position in the figure. For instance, in each figure, the top row of frames correspond to those provided by a station (e.g., station 104), and the bottom row of frames correspond to those provided by an AP (e.g., AP 102). Though not shown, each frame is separated from another by a defined interval, such as a SIFS, PIFS, etc. The blocks representing each of the frames are denoted in order of advancing sequence in time, as represented by the time line 201. For instance, in FIG. 2, RTS-ER precedes CTS1-ER in time. Additionally, the modulation method is also represented in each block as either an extended range (-ER) method (e.g., STBC) or a normal range (-NR) method (e.g., legacy). For purposes of the discussion that follows, station 106 is also referred to as an NR or legacy station, and station 104 is also referred to as an ER-capable station. Further, although each station 104 or 106 is referenced below in the singular, it would be understood by those having ordinary skill in the art in the context of this disclosure that a plurality of stations also applies.

Referring to FIG. 2, an RTS is transmitted by the ER-station 104 (i.e., using an ER modulation), that is RTS-ER 202. Responsive to receiving the RTS-ER 202, the AP 102 transmits via ER-modulation a first CTS, CTS1-ER 204. These two frames 202 and 204 each set a network allocation vector (NAV) in ER-capable stations, including ER-capable stations located outside the legacy (NR) range. Thus, the CTS1-ER 204 is received by ER-capable station 104, hence indicating that the AP 102 has received the RTS-ER 202. A short time after transmitting the CTS1-ER 204, the AP 102 sends via a normal range (e.g., NR, such as legacy) modulation a second CTS, that is CTS2-NR 206. The CTS2-NR 206 sets a NAV inside the legacy station 106. The CTS2-NR 206 may not be received by the requesting ER-capable station 104, but it does provide NAV coverage at legacy stations inside the network. The ER-capable station 104 knows that the AP 102 will transmit a second CTS (CTS2-NR 206), and also at what rate (e.g., the lowest possible rate), so the ER-capable station 104 postpones the transmission of the actual data frame(s) data PPDU-ER 208 until an SIFS time after the end of the CTS2-NR 206. The time interval between the CTS1-ER 204 and the CTS2-NR 206 can be a SIFS or PIFS interval. That is, the SIFS time between CTS1-ER 204 and CTS2-NR 206 can be extended to a PIFS, which may simplify the mechanism. In such circumstances, the second CTS is transmitted after the first CTS irrespective of whether the RTS is an NR or ER modulation. In some embodiments, the SIFS time between CTS2-NR 206 and data PPDU-ER 208 may be reduced to be less than SIFS, because the transmission of data PPDU-ER 208 is timed off of the end of the CTS1-ER 204, and CTS2-NR 206 does not need to be received. Therefore, station 104 can start the receive to transmit turnaround immediately after receiving CTS1-ER 204, rather than after CTS2-NR 206 (which may not be received by station 104 in the first place), which implies that station 104 can be ready to transmit data PPDU-ER 208 at any time after the end of CTS2-NR 206 (e.g., the turnaround starts after CTS1, and may take place during CTS2; the next transmission can start at any time after CTS2, with no SIFS needed).

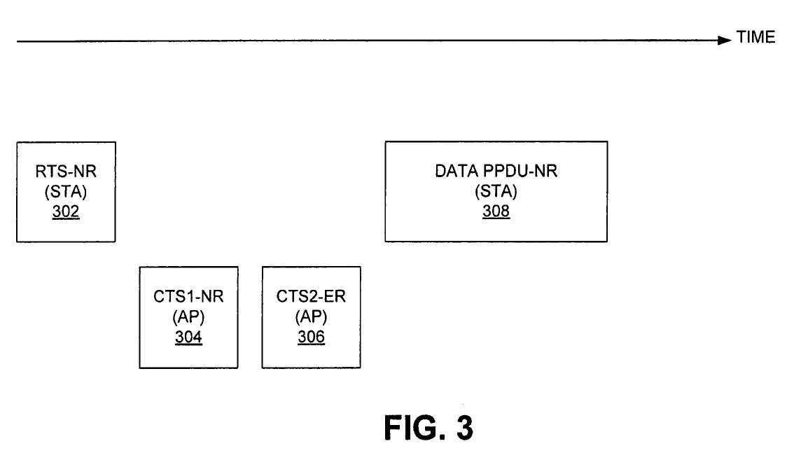

Referring to FIG. 3, shown is an illustration of a mechanism where a non-ER capable node or station 106 uses a legacy rate to send an RTS to the AP 102. As shown, the station 106 sends an RTS-NR 302, and the AP 102 responds with a first CTS response, CTS1-NR 304. Although the AP 102 uses a legacy rate for the first CTS response 304, the CTS1-NR 304 cannot be received by ER-capable stations (e.g., station 104) when they are too far away from the AP 102. To cover the ER stations, the AP 102 follows the CTS1-NR 304 with a PIFS interval and then a second CTS, CTS2-ER 306. The CTS2-ER 306 sets a NAV inside the ER-capable stations. Hence, the NAV is set twice, first by CTS1-NR 304 and second by CTS2-ER 306. The station 106 sends a data frame, PPDU-NR 308.

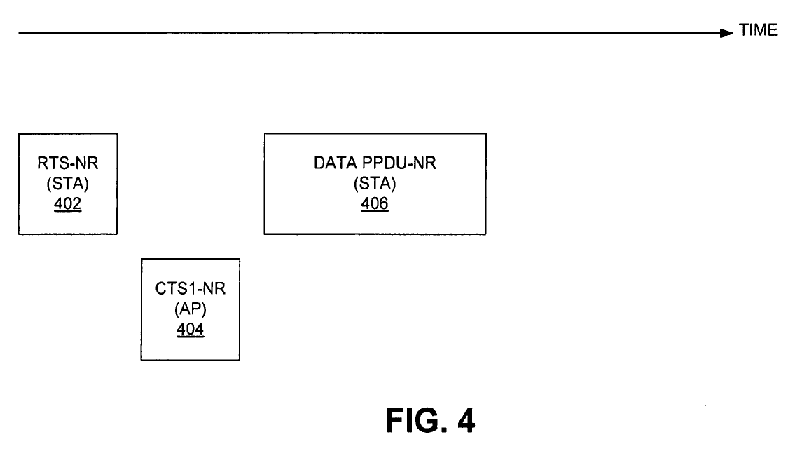

FIG. 4 illustrates an implementation that is based on the fact that, at least in some implementations, a PIFS time is required between a first and second CTS for a normal range RTS because legacy and non-ER compliant devices (e.g., station 106) expect a single CTS-response and hence continue SIFS after receiving the first CTS. Thus, as shown in FIG. 4, the station 106 sends an RTS-NR 402, and the AP 102 responds with a CTS1-NR 404. The AP 102 notices a busy medium after SIFS, and hence will not transmit a second CTS. Subsequent to the CTS1-NR 404, data PPDU-NR 406 is transmitted by the station 106. That is, in such an implementation, the DCTS system 200 refrains from sending a second CTS. Alternatively, if the AP 102 knows that all associated stations 104, 106 are dual CTS-aware, a SIFS can be used between a CTS1-NR and a CTS2-ER after an RTS-NR.

Note that in some embodiments, non-legacy stations which do not support ER can behave like legacy with respect to RTS/CTS exchanges, and transmit data SIFS after CTS1, or they can behave like ER stations and transmit data PIFS plus CTS2 plus SIFS time after receiving CTS1. Whether the AP 102 attempts to transmit a dual CTS can be indicated by a beacon, or through a setting inside a probe response or association response frames. Additionally, the dual CTS response may be transmitted by stations which are not APs, although less relevant given that the AP 102 covers all the associated stations in the network.

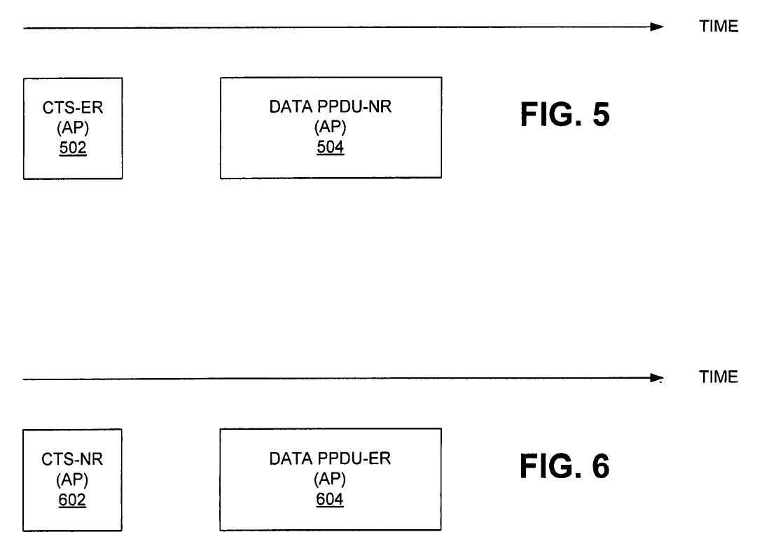

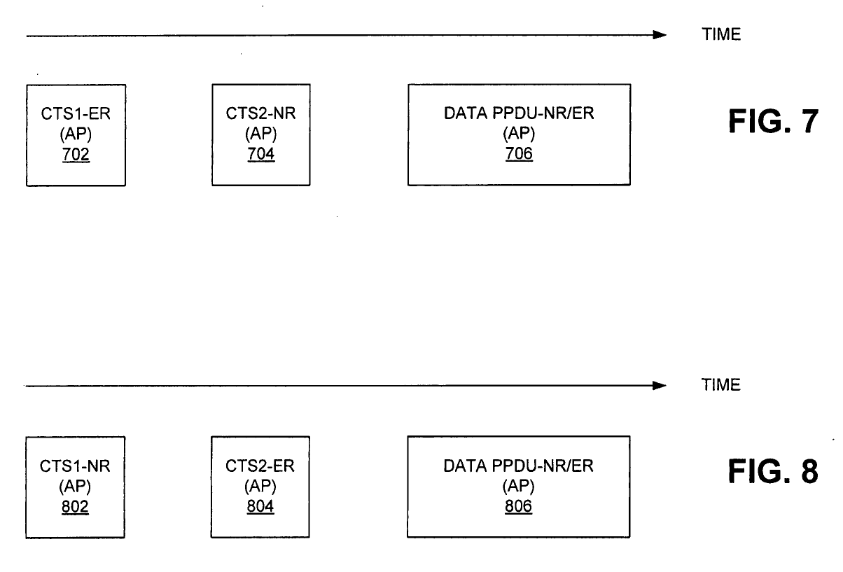

FIGS. 5-8 illustrate various mechanisms by which the DCTS system 200 provides NAV protection by beginning NR transmit opportunities (TXOPs) by a CTS-ER (or another short frame) and vice versa (i.e., ER TXOPs beginning with NR short frames) at an AP 102. Generally, FIGS. 5-6 illustrate that a CTS, when using alternate modulations, makes visible a pending transmission, and FIGS. 7-8 illustrate the sending of a CTS in both types of modulations to enable any type of frame to be sent afterwards. Thus, referring to FIG. 5, shown provided by an AP 102 is a CTS-ER 502 followed by a PPDU-NR 504. In FIG. 6, the AP 102 provides a CTS-NR 602 followed by a PPDU-ER 604.

Further, the AP 102 can also precede its TXOP by a dual CTS using both modulations (e.g., ER and NR). For instance, referring to FIG. 7, the AP 102 sends a CTS1-ER 702 followed by a CTS2-NR 704, and then followed by a PPDU-NR/ER 706 (e.g., NR/ER signifies the ability to be modulated according to ER or NR). In FIG. 8 the AP 102 sends a CTS1-NR 802 followed by a CTS2-ER 804 followed by a PPDU-NR/ER 806. The interframe spaces shown for the mechanisms in FIGS. 6-8 include SIFS, PIFS, or a mixture of both. Note that, although described in FIGS. 5-8 using a CTS, it would be understood by one having ordinary skill in the art that the CTS can be substituted in some embodiments with a short frame addressed at the sender.

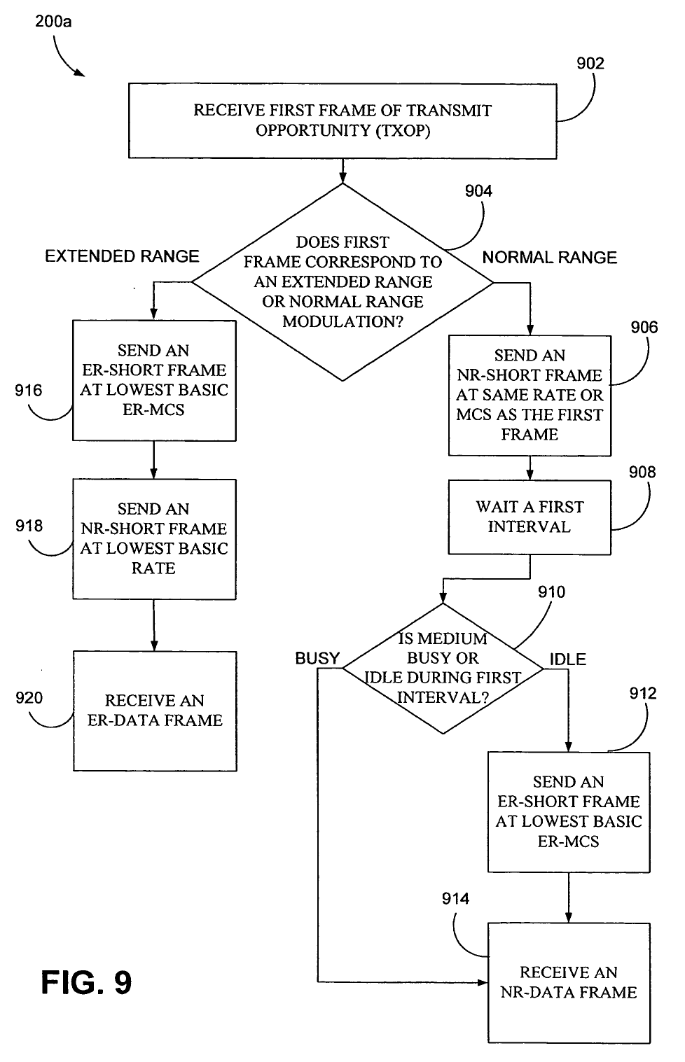

Having described various embodiments for the DCTS system 200, it can be appreciated that one method embodiment 200a (from the perspective of an AP), shown in FIG. 9 and corresponding to the mechanisms shown in FIGS. 2-4, comprises receiving a first frame of a transmit opportunity (TXOP), such as an RTS (902), determining whether the first frame corresponds to an ER or NR modulation (904), responsive to determining the first frame is an NR frame, sending an NR-short frame (e.g., CTS1-NR) at the same rate or MSC as the first frame (906), and waiting a first interval (e.g., PIFS) (908). The method 200a continues by determining whether the medium is busy or idle during the PIFS time (910), responsive to determining that the medium is idle, sending an ER-short frame (e.g., a CTS2-ER) at the lowest basic ER-MCS (912) and then receiving an NR-data frame (e.g., PPDU-NR) (914). If it is determined that a medium is busy, the data frame is received (914) without sending a second CTS.

Continuing from (904), responsive to determining that the first frame is an extended range modulated frame (RTS-ER), the method comprises sending an ER short frame (e.g., CTS1-ER) at the lowest basic ER-MSC (916), sending an NR short frame (e.g., CTS2-NR) at the lowest basic rate (918), and then receiving an ER-data frame (920).

It should be understood that other method embodiments are similarly shown in FIGS. 2-4 from the perspective of the station, as well as incorporating both ends of the communication exchange. For instance, from the perspective of the station, one method embodiment comprises the station transmitting an ER-RTS and delaying transmission of a data frame a defined interframe space timed after the end of a first CTS in some embodiments, or timed after a second CTS in some embodiments, as explained above.

Similarly, another method embodiment corresponding to the mechanism shown in FIG. 2 comprises sending an RTS-ER from an ER-capable station, receiving the RTS at the AP, and responsive to that receipt, sending a CTS-ER from the AP and a CTS-NR from the AP a defined interframe space after the CTS-ER, and then the station sending one or more ER data frames to the AP a defined time after receiving a CTS-ER.

Another method embodiment corresponding to the mechanism shown in FIG. 3 comprises sending an RTS-NR from an NR-capable station, receiving the RTS at the AP, and responsive to that receipt, sending a CTS-NR from the AP and a CTS-ER from the AP a defined interframe space after the CTS-NR, and then the station sending one or more NR data frames to the AP, a defined time after receiving a CTS-NR.

Another method embodiment corresponding to the mechanism shown in FIG. 4 comprises sending an RTS-NR from an NR-capable station, receiving the RTS at the AP, and responsive to that receipt, sending a CTS-NR from the AP, and while the medium is busy during a PIFS interval, the station sending one or more NR data frames to the AP a SIFS interval after receiving the CTS-NR.

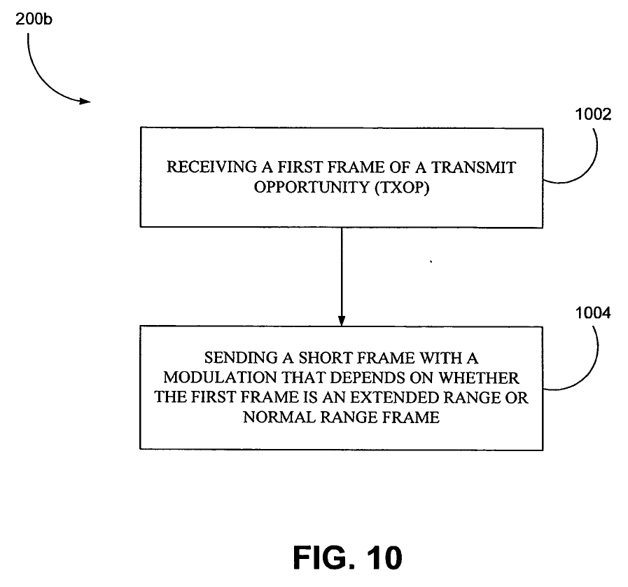

Another method embodiment 200b, shown in FIG. 10, comprises receiving a first frame of a TXOP (1002), and sending a short frame with a modulation that depends on whether the first frame is an extended range or normal range frame (1004).

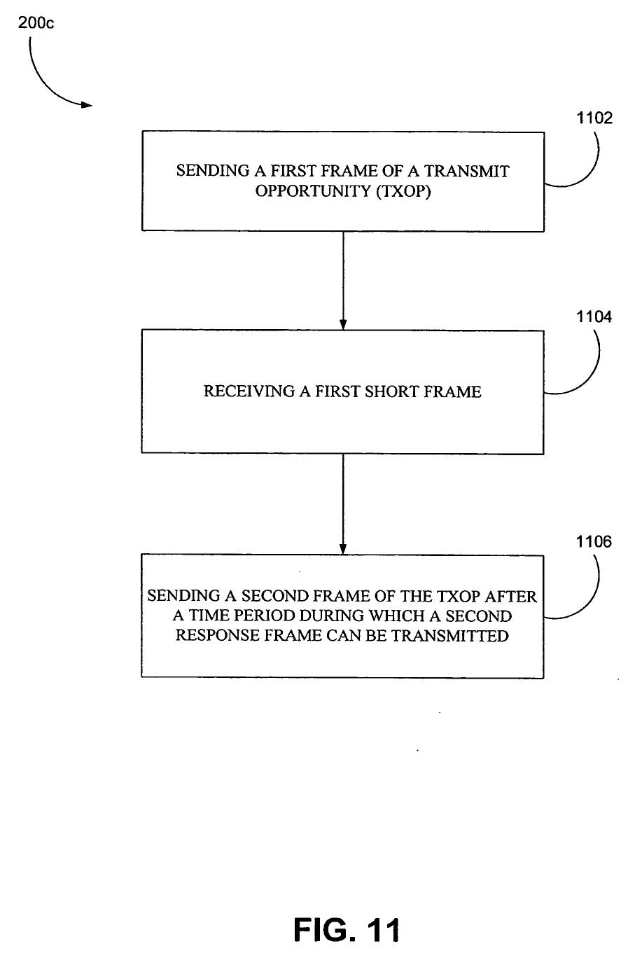

Another method embodiment 200c (taken from the perspective of a station), shown in FIG. 11, comprises sending a first frame of TXOP (1102), and receiving a first short frame (1104). The modulation of the first frame depends on whether the first frame is an extended range or normal range frame. The method 200c further comprises sending a second frame of a TXOP after a time period during which a second response frame can be transmitted by the AP (which the station may or may not see) (1106).

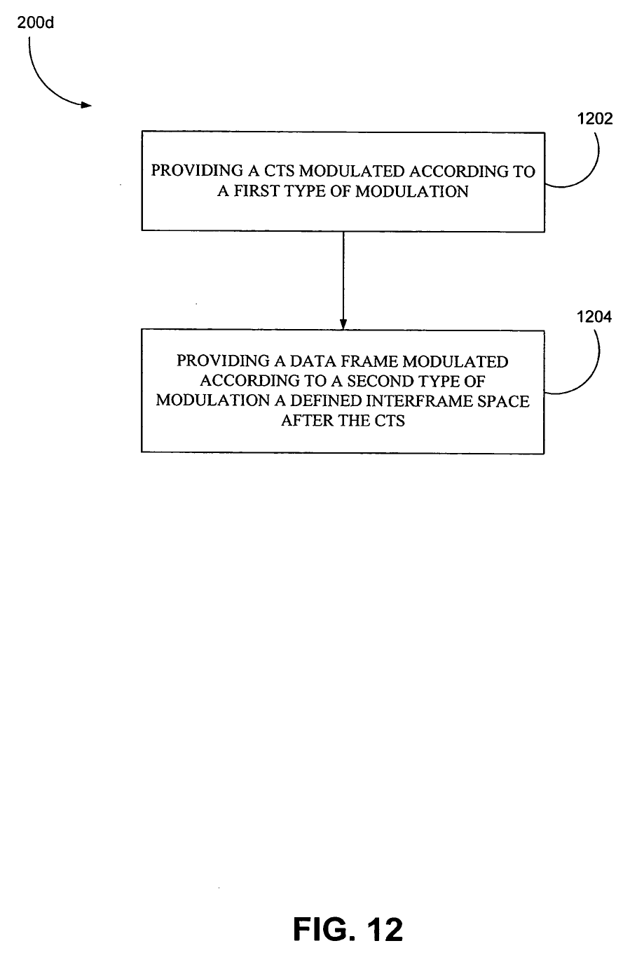

Another method embodiment 200d corresponding to the mechanisms shown in FIGS. 5-6 and shown in FIG. 12, comprises providing a CTS modulated according to a first type of modulation (1202), and providing a data frame modulated according to a second type of modulation a defined interframe space after the CTS (1204).

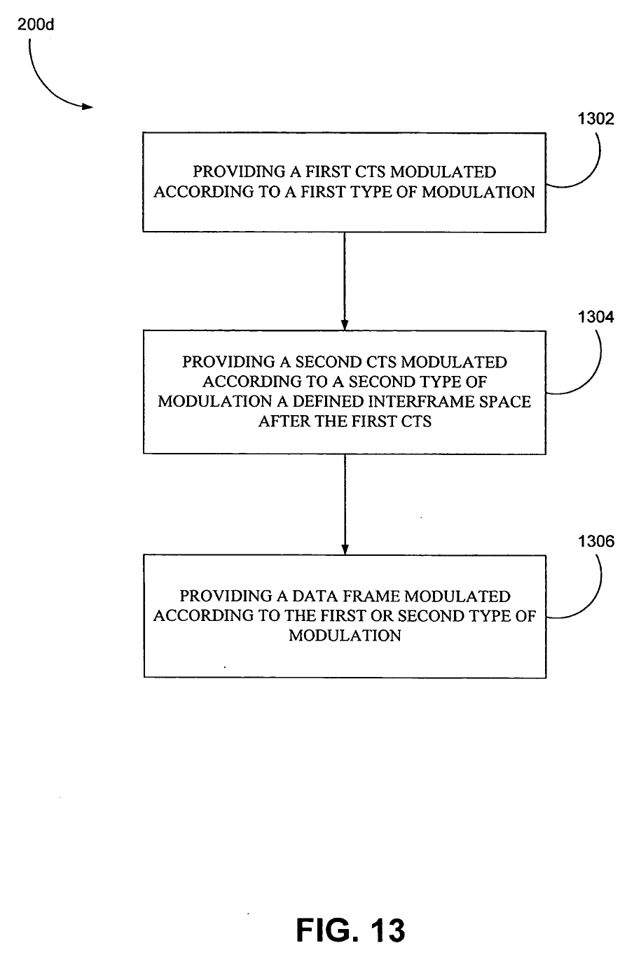

Another method embodiment 200e corresponding to the mechanisms shown in FIGS. 7-8 and shown in FIG. 13 comprises providing a first CTS modulated according to a first type of modulation (1302), providing a second CTS modulated according to a second type of modulation a defined interframe space after the first CTS (1304), and providing a data frame modulated according to the first or second type of modulation (1306).

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

Therefore, at least the following is claimed:

1. A method for providing network allocation vector (NAV) protection, comprising:
receiving a first frame of a transmit opportunity (TXOP); and
sending a short frame with a modulation that depends on whether the first frame is an extended range or normal range frame.

2. The method of claim 1, wherein sending the short frame comprises sending an extended range short frame when the first frame is an extended range first frame.

3. The method of claim 2, further comprising sending a normal range short frame that follows the extended range short frame after a defined interframe space.

4. The method of claim 3, wherein sending the extended range short frame and the normal range short frame comprises sending a first clear to send (CTS) and a second CTS, respectively.

5. The method of claim 3, wherein sending the extended range short frame comprises sending at an extended range modulation coding scheme.

6. The method of claim 3, wherein sending the normal range short frame comprises sending at one of a basic rate and a lowest basic rate.

7. The method of claim 3, wherein sending the extended range short frame comprises using one of a space time code block (STBC), direct sequence spread spectrum (DSSS), and complimentary code keying (CCK) modulation scheme, wherein the extended range short frame is followed by a non-extended range modulation scheme.

8. The method of claim 3, further comprising receiving an extended range data frame.

9. The method of claim 1, wherein receiving the first frame comprises receiving an RTS.

10. The method of claim 1, wherein sending the short frame comprises sending a normal range short frame when the first frame is a normal range first frame.

11. The method of claim 10, further comprising waiting an interval of time to determine if a medium in which the first frame and the short frame is transmitted is busy or idle.

12. The method of claim 11, wherein responsive to determining that the medium is idle, sending an extended range short frame.

13. The method of claim 12, wherein sending the extended range short frame comprises sending at a basic extended range modulation code scheme.

14. The method of claim 12, wherein sending the extended range short frame comprises sending a CTS.

15. The method of claim 12, further comprising receiving a normal range data frame.

16. The method of claim 11, wherein responsive to determining that the medium is busy, receiving a normal range data frame.

17. The method of claim 11, wherein waiting the interval of time comprises waiting a PIFS interval of time.

18. The method of claim 10, wherein sending the normal range short frame comprises sending at a same rate or modulation code scheme as the first frame.

19. The method of claim 10, wherein sending the normal range short frame comprises sending a CTS.

20. A method for providing network allocation vector (NAV) protection, comprising:
sending a first frame of a transmit opportunity (TXOP);
receiving a first short frame; and
sending a second frame of the TXOP after a time period during which a response frame can be transmitted.

21. The method of claim 20, wherein the second response frame is not received.

22. The method of claim 20, wherein the first short frame comprises a modulation that depends on whether the first frame is an extended range or normal range frame.

23. A method, comprising:
providing a clear to send (CTS) modulated according to a first type of modulation; and
providing a data frame modulated according to a second type of modulation a defined interframe space after the CTS.

24. A method, comprising:
providing a first clear to send (CTS) modulated according to a first type of modulation;
providing a second CTS modulated according to a second type of modulation a defined interframe space after the first CTS; and
providing a data frame modulated according to the first or second type of modulation.

25. A system, comprising:
a processor configured with logic to receive a first frame of a transmit opportunity (TXOP) and send a short frame with a modulation that depends on whether the first frame is an extended range or normal range frame.

26. The system of claim 25, wherein the processor is further configured with the logic to send an extended range short frame when the first frame is an extended range first frame.

27. The system of claim 26, wherein the processor is further configured with the logic to send a normal range short frame that follows the extended range short frame after a defined interframe space.

28. The system of claim 27, wherein the processor is further configured with the logic to consecutively send a first clear to send (CTS) followed by a second CTS.

29. The system of claim 25, wherein the processor is further configured with the logic to send a normal range short frame when the first frame is a normal range first frame.

30. The system of claim 29, wherein the processor is further configured with the logic to wait an interval of time to determine if a medium in which the first frame and the short frame is transmitted is busy or idle.

31. The system of claim 30, wherein responsive to determining that the medium is idle, the processor is further configured with the logic to send an extended range short frame.

32. The system of claim 30, wherein responsive to determining that the medium is busy, the processor is further configured with the logic to receive a normal range data frame.

33. A system, comprising:
a processor configured with logic to send a first frame of a transmit opportunity (TXOP), receive a first short frame, and send a second frame of the TXOP after a time period during which a response frame can be transmitted.

34. A system, comprising:
means for providing a clear to send (CTS) modulated according to a first type of modulation; and
means for providing a data frame modulated according to a second type of modulation a defined interframe space after the CTS.

35. A system, comprising:
means for providing a first clear to send (CTS) modulated according to a first type of modulation;
means for providing a second CTS modulated according to a second type of modulation a defined interframe space after the first CTS; and
means for providing a data frame modulated according to the first or second type of modulation.
